(19) United States
(12) Patent Application Publication
(10) Pub. No.: US 2007/0235283 A1
(43) Pub. Date: Oct. 11, 2007

(54) Digital home ecosystem validator & process

(76) Inventors: Mark A. Collins, Dripping Springs, TX (US); Darryl Konopka, Austin, TX (US)

Correspondence Address: HAMILTON & TERRILE, LLP, P.O. BOX 203518, AUSTIN, TX, 78720, US

(21) Appl. No.: 11/399,783

(22) Filed: Apr. 7, 2006

(51) Int. Cl. G07F 1/04

(52) U.S. Cl. 194/345

(57) ABSTRACT

An ecosystem validator which ensures that an information handling system, as configured by the user, is a valid hardware-software combination, the validator also performs a local environment scan of the user's existing ecosystem setup and uses the information obtained during this scan to ensure proper configuration of the information handling system for integration into the ecosystem. This scan includes, but is not limited to, existing computer systems, printers, networks, cameras, personal music devices and other consumer electronics. Based upon the information obtained, the information handling system is configured to seamlessly integrate into the ecosystem.

### BACKGROUND OF THE INVENTION

1. Field of the Invention

The present invention relates to information handling system support and more particularly to digital home ecosystem validator and process.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

This issue is particularly relevant when the ordered information handling system is a build to order computer system. A goal of information handling system manufacturers is to reduce overall customer support costs by enabling customers to support themselves.

One issue relevant to information handling systems relates to ordering new information handling systems to fit into a preexisting user environment. The user environment can include networked information handling systems, printing devices, consumer electronics devices as well as other types of digital devices including cameras, video recorders, and music players. The combination of all of these devices within an environment is known as the user ecosystem.

Currently, the purchase of a computing or digital media extender device to co-exist within a user's current environment can often be confusing and difficult. This is because the configuration and purchase typically focuses on just the single device without regard to interaction within a user's local computer use environment. As the proliferation of computers, networking and consumer electronic equipment continues to grow within a user's home, so do the myriad of choices and complexities involved in selecting the correct equipment to compliment that environment.

Stepping back away from the actual equipment, the digital home landscape begins to come into view. The customer's total environment, taken as a whole, is known as the ecosystem. Little has been done to address the entire ecosystem to interact with devices outside of the base computer system itself. There is also little available for the user to play what-if scenarios for potential setups within their home that would take into account and compliment their existing setup.

### SUMMARY OF THE INVENTION

In accordance with the present invention, an ecosystem validator is disclosed which ensures that an information handling system, as configured by the user, is a valid hardware-software combination, the validator also performs a local environment scan of the user's existing ecosystem setup and uses the information obtained during this scan to ensure proper configuration of the information handling system for integration into the ecosystem. This scan includes, but is not limited to, existing computer systems, printers, networks, cameras, personal music devices and other consumer electronics. Based upon the information obtained, the information handling system is configured to seamlessly integrate into the ecosystem. In certain embodiments, this ecosystem validator is extended to provide what-if simulations based upon additional product purchases from the information handling system supplier. The simulations provide a visual representation of the purchase and also provide avenues for selling customized install and support service offerings based upon a user's existing ecosystem setup. This type of customization might include correct configuration of provided equipment as well as possible changes in the setup or interconnection of equipment already owned by the customer.

More specifically, in one embodiment the invention relates to a system for enabling configuration of an information handling system. The system includes a configurator, the configurator configuring a system with options selected according to user input, the configurator including a validator, the validator validating configuration of the system and an ecosystem validator, the ecosystem validator validating configuration of the system within an ecosystem, a checkout module, the checkout module presenting payment options and obtaining payment and delivery information; and a database, the database receiving information from and supplying information to the configurator, the checkout module.

In another embodiment, the invention relates to a method for enabling configuration of an information handling system. The method includes configuring a system with options selected according to user input, the configuring including validating configuration of the system and validating configuration of the system within an ecosystem.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows access to the on-line store via the Internet using a computer system.

FIG. 3 shows a schematic diagram of a system for installing software.

FIG. 4 shows a schematic block diagram of an information handling system.

FIG. 5 shows s block diagram of an ecosystem validator within a configurator.

FIGS. 6A and 6B, generally referred to as FIG. 6, show a flow chart of the operation of ecosystem validator.

### DETAILED DESCRIPTION

An on-line store is one component of an Internet website to which a customer may go to configure a particular information handling system, for example, according to desired options of the customer. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

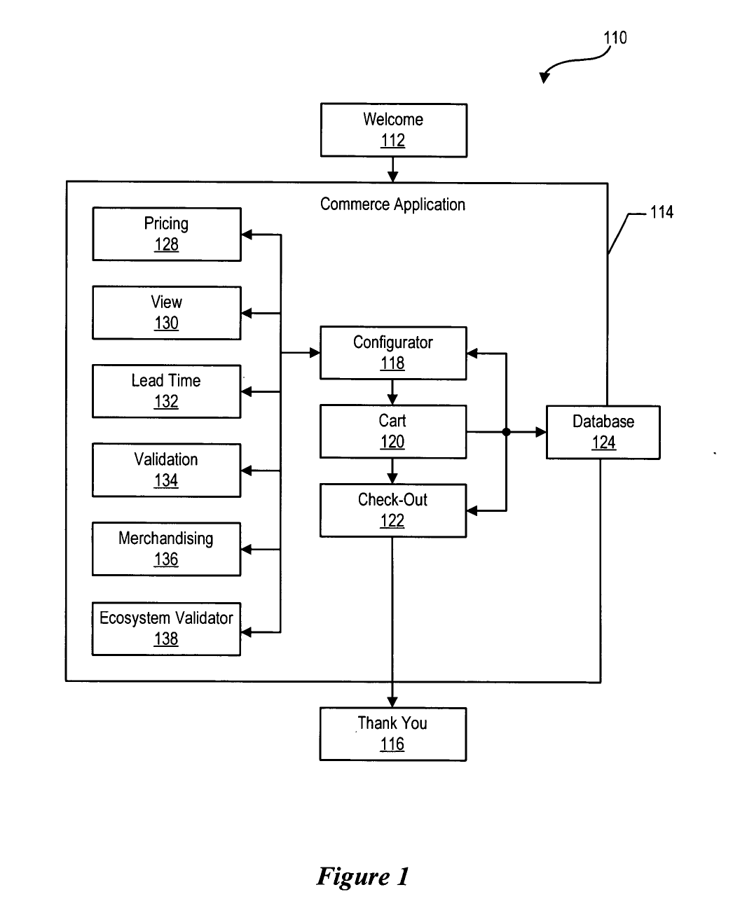

Referring now to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122. The configurator 118 includes a pricing module 128, a view module 130, a lead time warning module 132, a validation (or compatibility) warning module 134, a merchandising module 136 and an ecosystem validation module 138. The various modules of the configurator 118 are driven by data from the database 124, and thus the configurator 118, shopping cart 120, and checkout module 122 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, and the thank you module 116 presents a thank you page. The welcome page includes a static page and generally resides outside of the commerce application 114. The configurator page, shopping cart page, and checkout page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, and checkout module 122 are each part of the commerce application 114 and interact with the database 124. For example, with the shopping cart 120, additional merchandising information associated with a particular system which has been configured and placed in the shopping cart by an on-line store customer can be provided.

The ecosystem validator ensures that an information handling system, as configured by the user, is a valid hardware-software combination. The ecosystem the validator also performs a local environment scan of the user's existing ecosystem setup and uses the information obtained during this scan to ensure proper configuration of the information handling system for integration into the ecosystem. This scan includes, but is not limited to, existing computer systems, printers, networks, cameras, personal music devices and other consumer electronics. Based upon the information obtained, the information handling system is configured to seamlessly integrate into the ecosystem.

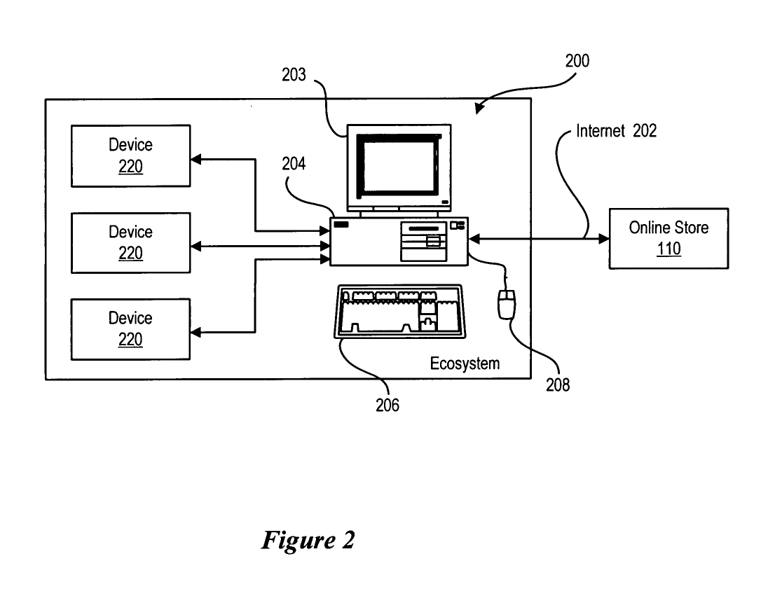

Referring to FIG. 2, a customer can access the on-line store 110 using any suitable computer system 200, via the Internet 202. The computer system 200 may include a display 203, computer 204, keyboard 206, and pointing device 208. Display 203 is used for displaying the various pages of the on-line store while a customer is using the on-line store. The computer equipment 200 may be coupled, either directly, wirelessly or virtually, to one or more devices 220. The combination of the computer system 200 and the other devices 220 becomes the ecosystem 230 of the computer system 200.

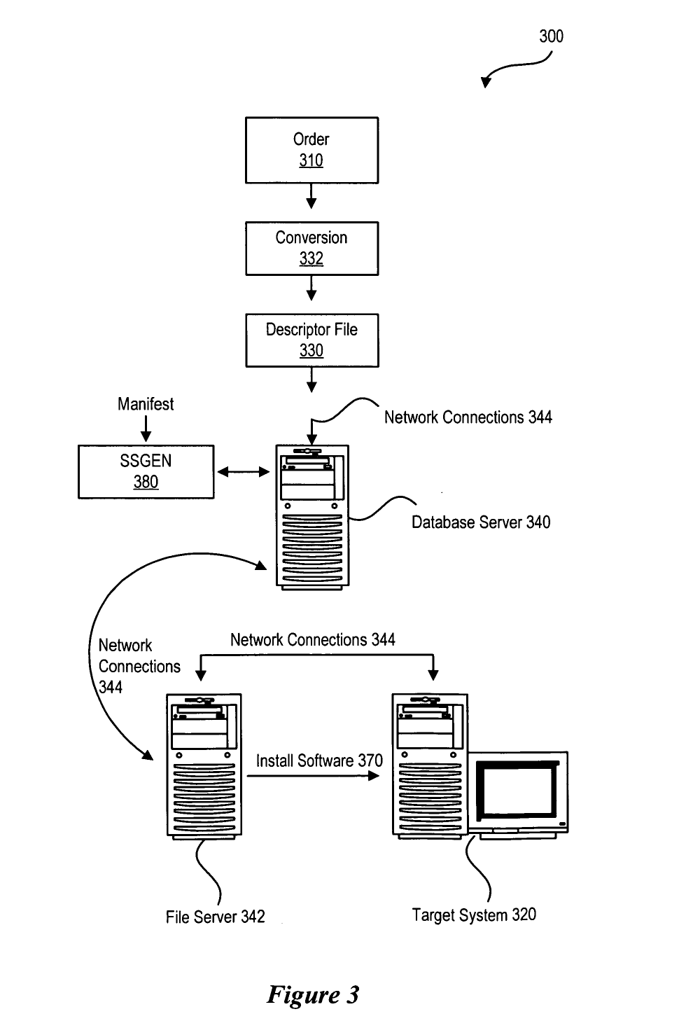

FIG. 3 is a schematic diagram of a software installation system 300 at an information handling system manufacturing site. In operation, an order 310 is placed to purchase a target information handling system 320, via, e.g., the on-line store. The target information handling system 320 to be manufactured contains a plurality of hardware and software components. For instance, target information handling system 320 might include a certain brand of hard drive, a particular type of monitor, a certain brand of processor, as well as particular software products and preordered services. The software may include a particular version of an operating system along with all appropriate driver software and other application software along with appropriate software bug fixes. Before target information handling system 320 is shipped to the customer, the plurality of components are installed and tested. Such software installation and testing advantageously ensures a reliable, working information handling system which is ready to operate when received by a customer.

The installation includes installing components determined to be desirable based upon the ecosystem validation process. The testing includes testing for components that were installed based upon the ecosystem validation process.

Because different families of information handling systems and different individual computer components may require different software installations, it is desirable to determine which software to install on a target information handling system 320. A descriptor file 330 is provided by converting an order 310, which corresponds to a desired information handling system having desired components, into a computer readable format via conversion module 332. The descriptor file 330 includes components component descriptors corresponding to components determined to be desirable based upon the ecosystem validation process.

Component descriptors are computer readable descriptions of the components of target information handling system 320 which components are defined by the order 310. In a preferred embodiment, the component descriptors are included in a descriptor file called a system descriptor record which is a computer readable file containing a listing of the components, both hardware and software, to be installed onto target information handling system 320. Having read the plurality of component descriptors, database server 340 provides an image having a plurality of software components corresponding to the component descriptors to file server 342 over network connection 344. Network connections 344 may be any network connection well-known in the art, such as a local area network, an intranet, or the internet. The information contained in database server 340 is often updated such that the database contains a new factory build environment. The software is then installed on the target information handling system 320 via file server 342. The software is installed on the target information handling system via the image. The image may include self-configuring code.

The database server 340 may also be updated via a software stack generator machine 380. The software stack generator (SSGEN) machine 380 is capable of downloading and installing a configurable set of software parts and then automatically capturing an image of the contents, optionally uploading the image to a shared server such as the database server 340 for later use. The software stack generator machine 380 is capable of being controlled by a centralized front end, thus allowing two or more software stack generator machines to be set up in an image building farm.

In operation, automating the generation of images provides the ability to download the parts to be installed into the image from a network or other storage device. The software stack generator machine 380 may include scriptable package delivery mechanisms. The software stack generator machine 380 may include or receive images which include an integrated rapid install system (IRIS). The integrated rapid install system may then be installed onto the target system when the image is installed onto the target system.

Images to be created are described using a manifest which is represented, e.g., as an XML document. The contents of the image include some or all of a base operating system, application programs, applets (for hardware), etc. The manifest is provided to the software stack generator machine 342 and causes the image building process to begin. After the image is created, the image can be installed onto a target system 320 such that the building of the image is transparent to the target system. For example, the SSGEN machine 380 removes anything from the registry of the operating system that would indicate that the software stack was created by the SSGEN machine 380.

The components also include a customized customer support application. The customized customer support application includes a process by which support content is specifically tailored to what was purchased at the point of sale. The customer support application includes a configuration determination module and a tailored customer support module. The configuration determination module of the customer support application comprehends what hardware, software and services were purchased. The tailored customer support module uses the information determined by the configuration determination module to tailor initial support content based upon the specific configuration of the target information handling system 320.

For example, instead of providing generic instructions for “How do I get on the Internet?” the target information handing system 320 includes specific content on “How do I get online with the services promotion that was included with my system purchase.” Thus, the customer support application provides customized support experience which includes relevant support information and does not provide the user with too much irrelevant information or having to provide information which the user needs to understand to structure a query to obtain the information that the customer needs.

During the installation of the customized customer support application, the support application generates XPATH queries based upon the system order 310.

These queries are then used to reduce and focus support content which is loaded on the target information handling system 320 in a generic format, such as an XML format. When a customer accesses the customer support application, the customer has the option of using a simplified and focused support experience or turning off the focused content and to thus view all unfiltered content. The customized customer support application enables an information handling system manufacturer to reduce call volume regarding “how to” questions. The customized customer support application is especially beneficial as information handling systems offer more complex service based applications and hardware configurations as well as ecosystem specific configurations.

The customized customer support application tailors support content for service based applications such as internet services provider applications or digital entertainment applications, but is also applicable to hardware support content.

Additionally, the process can further tailor a support experience based upon decisions that are made by the user during configuration of the ordered information handling system such as whether a particular service has been activated by the user.

For example, if a user has not registered for or activated a service based application, the support experience would show the user how to register or activate the service. Alternately, if a user has registered or activated the service based application, then the support experience would be tailored to display content relating to how to user the service.

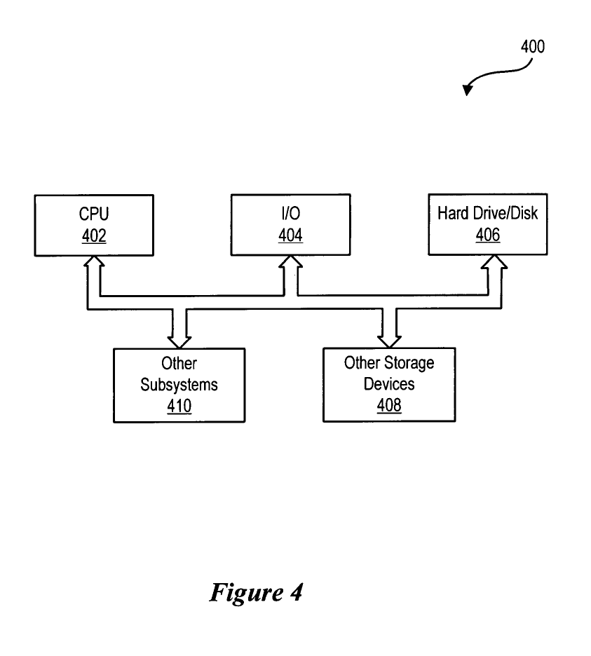

Referring to FIG. 4, a system block diagram of an information handling system 400 such as target information handling system 120 is shown. The information handling system 400 includes a processor 402, input/output (I/O) devices 404, such as a display, a keyboard, a mouse, and associated controllers, memory 206 including non-volatile memory such as a hard disk drive and volatile memory such as random access memory, and other storage devices 408, such as a floppy disk and drive and other memory devices, and various other subsystems 410, all interconnected via one or more buses, shown collectively as bus 412.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

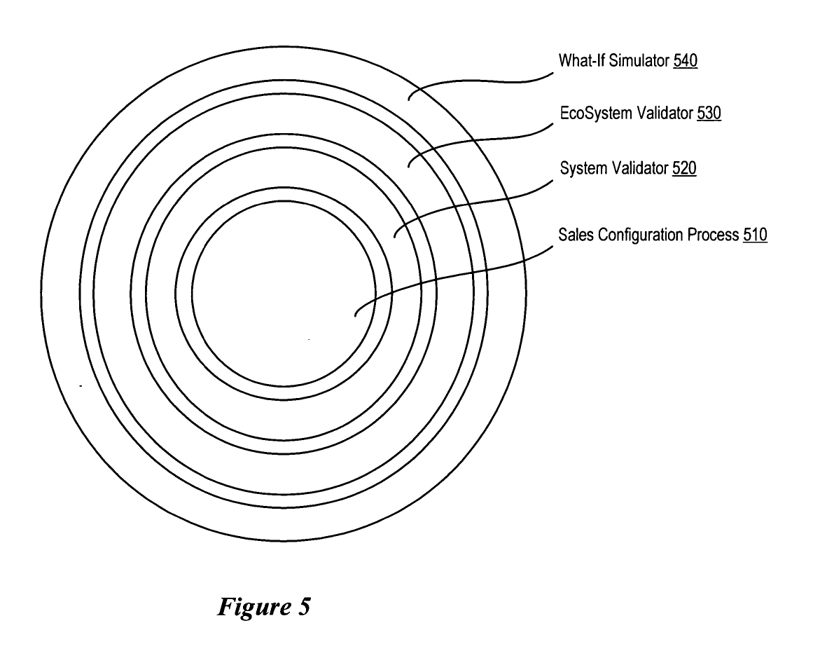

Referring to FIG. 5, a block diagram of a ecosystem validator within a configurator is shown. More specifically, when an information handling system is configured, e.g., during an on-line purchase, the process starts with a sales configuration process 510. Next the system validator 124 performs a validation of the configured system 520. Next, the ecosystem validator 138 validates the configured system in the context of the ecosystem in which the configured system will reside 530. Finally, a user may optionally be presented with a what-if simulator that enables the user to perform what-if simulations based upon additional product purchases from the information handling system supplier. The simulations provide a visual representation of the purchase and also provide avenues for selling customized install and support service offerings based upon a user's existing ecosystem setup. This type of customization might include correct configuration of provided equipment as well as possible changes in the setup or interconnection of equipment already owned by the customer.

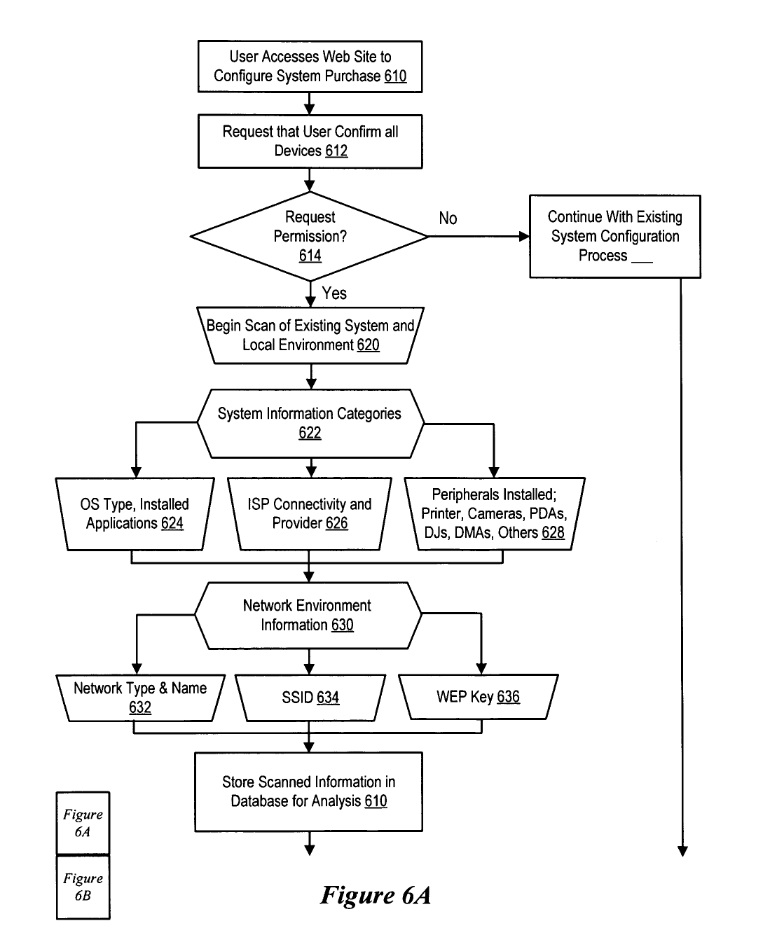

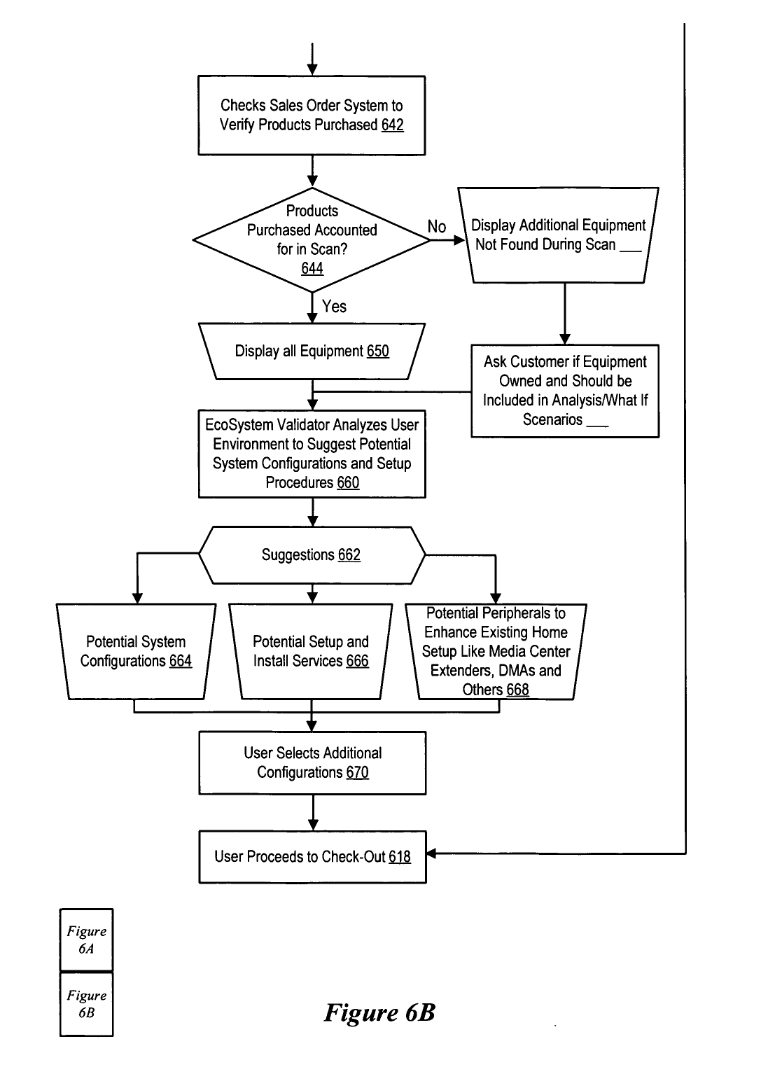

FIGS. 6A and 6B, generally referred to as FIG. 6, show a flow chart of the operation of the ecosystem validator 138. More specifically, the ecosystem validation process starts when a user accesses the configuration or ecosystem validation web site (such as the on-line store 110) to configure a system purchase at step 610. During the configuration process, the ecosystem validator 138 request that a user confirm all devices 220 are on the network and powered on at step 612. Next, the ecosystem validator 138 requests permission to scan the local environment to determine potential configuration information at step 614. If permission is not granted, then the operation continues with the system configuration and order process at step 616 and ultimately the user proceeds to check out at step 618.

When permission is granted, then the ecosystem validator begins a scan of the user's existing system (i.e., the system 200 via which the new system is being ordered and configured) as well as the rest of the user's local ecosystem at step 620. Next, the ecosystem validator 138 detects system information and divides the system information into a plurality of categories at step 622. There are a plurality of types of system information that are detected at step 622. These categories into which the information is divided information can include operating system (OS) type and installed applications 624, internet service provider (ISP) connectivity and provider information 626 as well as peripheral information 628. The peripheral information can include information regarding the types of peripherals installed including printers, cameras, personal digital assistants (PDAs) music players (e.g. MP3 players) and digital media adapters (DMAs) as well as other peripheral devices. The peripheral information can also include information regarding application and drivers that are installed for particular peripherals.

Next, the ecosystem validator 138 detects network environment information at step 630. The network environment information can include network type and name information 632, service set identifier (SSID) information 634 and wired equivalent privacy (WEP) key information 636

Next the ecosystem validator 138 stores the acquired information into a database (e.g., database 124) for analysis at step 640. Next the ecosystem validator 138 checks the sales order system to verify and identify any products that have been configured or purchased at step 642. Next the ecosystem validator 138 determines whether all products that were purchased (either presently or at some prior time) are accounted for within the local ecosystem scan at step 644.

If all products that have been purchased are not accounted for, then the ecosystem validator 138 displays the additional equipment not found during the scan at step 646 and asks the customer if the equipment is still owned and should be included in any analysis or what if scenarios at step 648. After the customer so indicates, then the equipment found by the ecosystem validator 138 is displayed to the customer at step 650. This display includes any equipment indicated by the customer at step 648.

Next the ecosystem validator 138 analyzes the user environment to suggest potential system configurations and set up procedures at step 660. The suggestions may be divided into categories at step 662. These suggestion categories can include potential system configurations 664, potential setup and install services 666 and potential peripherals to enhance an existing home ecosystem setup 668. The potential setup and install services can include suggestions for a particular ISP, for a home router, for a particular type of family of printer or for a file sharing capability. The potential peripherals can include a media center extender, a digital media adapter (DMA) or other peripherals that might enhance the ecosystem.

Next the user selects any additional configurations based upon the analysis and suggestions at step 670. The information derived from the ecosystem analysis is used to provide a ecosystem tailored out of box experience as well as enabling any ordered information handling systems to be configured based upon the ecosystem validation information. After the ecosystem validation completes, then the user proceeds to check out at step 618.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A system for enabling configuration of an information handling system comprising:
a configurator, the configurator configuring a system with options selected according to user input, the configurator including
a validator, the validator validating configuration of the system; and,
an ecosystem validator, the ecosystem validator validating configuration of the system within an ecosystem;
a checkout module, the checkout module presenting payment options and obtaining payment and delivery information;
a database, the database receiving information from and supplying information to the configurator, the checkout module.

2. The system of claim 1 wherein:
the ecosystem validator ensures that an information handling system, as configured by the user, is a valid hardware-software combination.

3. The system of claim 1 wherein:
the ecosystem validator performs a local environment scan of an existing ecosystem setup of the user.

4. The system of claim 3 wherein:
the ecosystem validator uses the information obtained during the scan to ensure proper configuration of the information handling system for integration into the ecosystem.

5. The system of claim 3 wherein:
the scan includes at least some of existing computer systems, printers, networks, cameras, personal music devices and consumer electronics devices.

6. The system of claim 1 wherein:
based upon information derived during ecosystem validation, the information handling system is configured to seamlessly integrate into the ecosystem.

7. An apparatus for enabling configuration of an information handling system comprising:
a configurator, the configurator configuring a system with options selected according to user input, the configurator including
means for validating configuration of the system; and,
means for validating configuration of the system within an ecosystem;
a checkout module, the checkout module presenting payment options and obtaining payment and delivery information;
a database, the database receiving information from and supplying information to the configurator, the checkout module.

8. The apparatus of claim 7 wherein:
the means for validating configuration of the system within an ecosystem ensures that an information handling system, as configured by the user, is a valid hardware-software combination.

9. The apparatus of claim 7 wherein:
the means for validating configuration of the system within an ecosystem performs a local environment scan of an existing ecosystem setup of the user.

10. The apparatus of claim 9 wherein:
the means for validating configuration of the system within an ecosystem uses the information obtained during the scan to ensure proper configuration of the information handling system for integration into the ecosystem.

11. The apparatus of claim 9 wherein:
the scan includes at least some of existing computer systems, printers, networks, cameras, personal music devices and consumer electronics devices.

12. The apparatus of claim 7 wherein:
based upon information derived during ecosystem validation, the information handling system is configured to seamlessly integrate into the ecosystem.

13. A method for enabling configuration of an information handling system comprising:
configuring a system with options selected according to user input, the configuring including
validating configuration of the system; and,
validating configuration of the system within an ecosystem.

14. The method of claim 13 wherein:
the validating configuration of the system within an ecosystem ensures that an information handling system, as configured by the user, is a valid hardware-software combination.

15. The method of claim 13 wherein:
the validating configuration of the system within an ecosystem includes performing a local environment scan of an existing ecosystem setup of the user.

16. The method of claim 13 wherein:
the validating configuration of the system within an ecosystem uses the information obtained during the scan to ensure proper configuration of the information handling system for integration into the ecosystem.

17. The method of claim 13 wherein:
the scan includes at least some of existing computer systems, printers, networks, cameras, personal music devices and consumer electronics devices.

18. The method of claim 13 wherein:
based upon information derived during ecosystem validation, the information handling system is configured to seamlessly integrate into the ecosystem.
